(19) United States
(12) Patent Application Publication
(10) Pub. No.: US 2002/0015243 A1
(43) Pub. Date: Feb. 7, 2002

(54) Flexible mirror assembly

(76) Inventors: Andrew Zachary Glovatsky, Plymouth, MI (US); Robert Edward Belke, West Bloomfield, MI (US); Jay DeAvis Baker, Dearborn, MI (US); Joseph Mario Giachino, Farmington Hills, MI (US); Lakhi Nandlal Goenka, Ann Arbor, MI (US); Myron Lemecha, Dearborn, MI (US)

Correspondence Address: BRINKS HOFER GILSON & LIONE, P.O. Box 10395, Chicago, IL, 60610, US

(21) Appl. No.: 09/904,230

(22) Filed: Jul. 12, 2001

Related U.S. Application Data
(60) Provisional application No. 60/218,493, filed on Jul. 14, 2000.

(51) Int. Cl. G02B 5/08; G02B 17/00; G02B 7/182

(52) U.S. Cl. 359/877; 359/607; 359/871

(57) ABSTRACT

A flexible mirror assembly is provided. The mirror assembly includes a mold line structure unit having a flexible mirror surface secured to a flexible panel. An actuator induces deformation of the flexible mirror surface such that it alters an angle at which the mirror surface reflects light.

### REFERENCE TO PREVIOUS APPLICATION

This application claims the benefit of United States Provisional Application No. 60/218,493 filed on Jul. 14, 2000.

### FIELD OF THE INVENTION

The present invention relates to flexible mirrors. More particularly, the invention relates to assemblies containing flexible mirrors that are particularly well-suited for use with motor vehicles.

### BACKGROUND OF THE INVENTION

Continuous mold line technology provides a continuous, smooth surface that can deform or stretch in a selective manner. This technology has been used in aircraft surfaces to reduce turbulence and drag due to gaps and discontinuities that arise in aircraft control surfaces upon movement of the surface. Individual mold line structure units provide distinct flexible surfaces that can be selectively activated to deform.

Conventional motor vehicle mirrors suffer from blind spots due to the rigidity of the mirror surface and the location of some vehicle structural components. Blind spots can arise in both side and rearview mirrors. As a result of these blind spots, an occupant of the vehicle cannot utilize the mirror to view objects within the area of the blind spot.

### SUMMARY OF THE INVENTION

The present invention provides mirror assemblies particularly well-suited for use with motor vehicles. The assemblies include a flexible mirror surface disposed on a flexible panel of one or more mold line structure units. In this arrangement, the flexible mirror surface can be deformed by activating, or inducing, the mold line structure unit to deform.

In a preferred embodiment, a flexible mirror assembly according to the present invention comprises a base member, a guide member having first and second opposing faces and defining a passageway between the first and second faces, at least one flexible rod attached to the base member and disposed in the passageway, a flexible panel disposed around the rod and between the base and guide members, a mirror surface disposed on the flexible panel, and an actuator adapted to induce deformation of the rod. One end of the rod is fixedly attached to the base member and the second end is capable of slideable movement within the passageway. As such, the rod, flexible panel, and flexible mirror surface are able to deform in response to a force by the actuator. The deformation of the mirror surface alters an angle at which the mirror surface reflects light.

The flexible mirror assembly can be disposed in a housing and mounted as a side or rearview mirror in a motor vehicle.

Also, a roller assembly can be connected to the actuator such that the actuator is adapted to induce continued deformation of the flexible mirror surface along a length thereof.

The mirror assembly can be adapted such that the flexible rod and/or panel are heated. The heating of these elements allows the flexible mirror surface to be warmed, which can be used to defrost the mirror surface.

A controller can be operably connected to the flexible mirror assembly and positioned within a passenger compartment of the vehicle such that an occupant of the vehicle can initiate and control deformation of the mirror surface.

### BRIEF DESCRIPTION OF THE DRAWINGS

FIG. 1 illustrates a perspective view of a mold line structure unit having a flexible mirror surface secured to the flexible panel.

FIG. 2 presents a cross-sectional view of the mold line structure unit shown in FIG. 1, taken along line 2-2.

FIG. 3 illustrates a perspective view of a flexible mirror assembly in accordance with a first preferred embodiment of the present invention.

FIG. 3A illustrates the assembly in a non-activated, or non-deformed, configuration.

FIG. 3B illustrates the assembly in an activated configuration in which the mirror surface is deformed.

FIG. 4 illustrates a perspective view of a flexible mirror assembly in accordance with a second preferred embodiment of the present invention.

FIG. 4A illustrates the assembly in a non-activated, or non-deformed, configuration.

FIG. 4B illustrates the assembly in an activated configuration in which the mirror surface is deformed.

FIG. 5 illustrates a perspective view of a flexible mirror assembly in accordance with a third preferred embodiment of the present invention.

### DETAILED DESCRIPTION OF THE INVENTION

The following description of preferred embodiments of the invention provides examples of the present invention. The embodiments discussed herein are merely exemplary in nature, and are not intended to limit the scope of the invention in any manner. Rather, the description of these preferred embodiments serves to enable a person of ordinary skill in the relevant art to make and use the present invention.

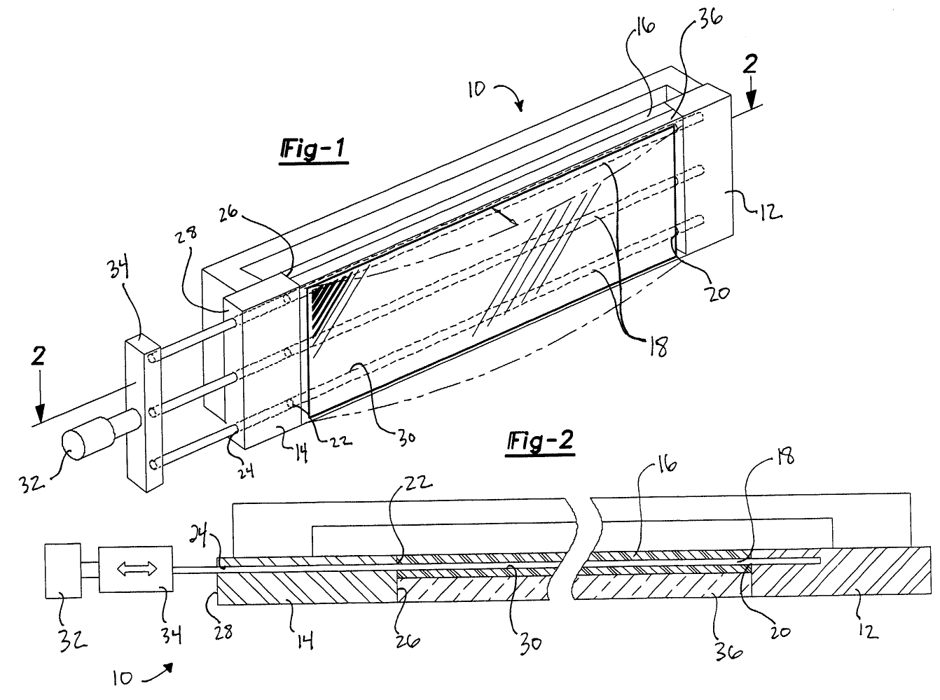

FIG. 1 illustrates an example of a moldline structure unit 10 that can be utilized in the present invention. The unit 10 includes a base member 12, a guide member 14, and a flexible panel 16 extending between the base 12 and guide 14 members. One or more flexible rods 18 extend through the flexible panel 16 and into both the base 12 and guide 14 members. The base 12 and guide 14 members are preferably secured to a surface.

The base member 12 preferably defines one or more openings 20 that receive and retain one end of the rods 18. In the base member 12, the openings 20 preferably retain the rods 18 such that the rod 18 cannot move within the opening 20. The rod 18 may be secured in the opening 20 by any of a variety of means, including an adhesive bond between the rod 18 and base member 12, mechanical attachment, such as crimping or by way of a fastener, etc. Alternatively, the rod can be secured to a face of the base member 12.

The guide member 14 defines openings 22 that provide a passageway 24 from a first face 26 to an opposing second face 28 of the member 14. Each opening 22 receives a second end of a rod 18 and allows the rod 18 to move freely within the passageway 24. Preferably, a free end of each rod 18 extends past the second edge 28 so that the flexible panel 16 can be deformed by passing a portion of the free end into the passageway 24, as will be developed more fully below.

The flexible panel 16 preferably comprises a flexible polymeric material that surrounds the portion of the rods 18 that lies between the base 12 and guide 14 members. Particularly preferable, the flexible panel 16 comprises an elastomeric material. Alternatively, the flexible panel can comprise any flexible material that is able to stretch or deform to a desired degree and return to its original form. The appropriate degree of ability to deform will depend on the application. For applications of the present invention, the flexible panel 16 is preferably capable of stretching to 150% of its normal length and still be able to return to its original length and form. Examples of suitable materials for use in the flexible panel of the present invention include rubber, silicones, silicone rubbers, polyurethanes, and flexible acrylics.

The flexible panel 16 defines one or more cavities 30 that receive the rods 18. Preferably, the flexible panel 16 defines one cavity 30 for each rod 18. Alternatively, the flexible panel 16 may define a single, relatively large cavity that receives a plurality or all of the rods 18. The cavities 30 receive the rods 18 in a manner that allows the rods 18 to move within the cavities 30. That is, the flexible panel 16 is preferably able to slide over the rods 18, via the cavities 30, as the rods 18 are pushed or pulled into or out of the cavities 30.

The rods 18 are also flexible in nature. Preferably, the rods 18 comprise a composite material that is sufficiently flexible to allow the flexible panel 16 to stretch to its full capacity. Also preferable, the rods 18 are able to bend and/or deform in a manner that confers a smooth, continuous shape to the flexible panel 16. Composite materials, such as carbon fiber and polymeric materials, provide the desired flexibility when acted upon by an external mechanical force, such as a pushing or pulling action, which will be developed more fully below. As an alternative to composite materials, the rods 18 can comprise any material that possesses the desired flexibility. Examples of suitable alternative materials for use in the rods of the present invention include aluminum, steel, and alloyed iron.

The rods 18 preferably comprise elongate, cylindrical shaped members that can be secured to the base member 12 and can be threaded through the passageway(s) 24 of the guide member 14 and the cavity(ies) 30 of the flexible panel 16. Alternatively, any other suitable shape, such as the flexible plates described in U.S. Pat. No. 5,810,291 to Geiger, et al., for a CONTINUOUS MOLDLINE TECHNOLOGY SYSTEM, which is hereby incorporated by reference in its entirety, can be utilized. Also alternatively, a series of individual rods positioned in parallel or twisted together can be utilized. Of course, the shape of the passageway(s) 24 and cavity(ies) 30 is preferably complimentary to that of the rods 18 such that the desired flexibility can be achieved.

The unit 10 also preferably includes an actuator 32. The actuator 32 is a device capable of inducing stretching of the flexible panel 16 and the rods 18. The type of actuator used will depend on the nature of the rods 18. For example, a mechanical actuator can be utilized to push or pull the rods 18 such that the desired stretching is achieved. The actuator 32 preferably comprises a motor or other mechanical device. Particularly preferred, the actuator 32 is a motor having a cam 34 that can induce stretching in the rods 18. Alternatively, any other suitable actuator that can induce stretching can be utilized, such as actuators employing hydraulic, pneumatic, or electrical means of inducing movement.

The actuator 32 can interact with the unit 10 to achieve the desired stretching in a variety of ways. For example, the actuator 32 can be attached to the free end of each rod 18 such that the actuator 32 can push or pull the rod 18 into or out of the passageways 24 and cavities 30. Alternatively, the cam 34 can be positioned such that it pushes or pulls the rod 18, either at the free end or at another location along its length, such that the rod 18 and flexible panel 16 stretch. Also, it is preferred that the actuator 32 be able to induce stretching in all rods present in the unit 10. Alternatively, the actuator 32 may induce stretching in only one rod, or a subset of rods.

A flexible mirror surface 36 is disposed on the flexible panel 16 of the moldline structure unit 10. The flexible mirror surface 36 provides a reflective surface that reflects light. Preferably, the flexible mirror surface comprises a metallic film. Alternatively, any suitable reflective surface having the desired flexibility can be used. Also alternatively, laminate arrangements, such as that described in U.S. Pat. No. 5,222,000 to Adler for a FLEXIBLE MIRROR, which is hereby incorporated by reference in its entirety, can be used.

The flexible mirror surface 36 is preferably sufficiently flexible to allow the surface 36 to deform as the rod 18 and flexible panel 16 deform. Also preferably, the mirror surface is fixedly secured to the flexible panel 16. Any suitable securement means can be utilized, but an adhesive bond between the surface 36 and flexible panel 16 is preferred.

It should noted that, when an appropriate actuator is used, such as that described for the second and third preferred embodiments herein, the rods can be eliminated. Furthermore, with an actuator that indices deformation by acting on the rods, such as that described for the first preferred embodiment herein, the flexible panel can be eliminated. In this arrangement, the mirror surface is preferably secured to the rods, either directly or by a coupling.

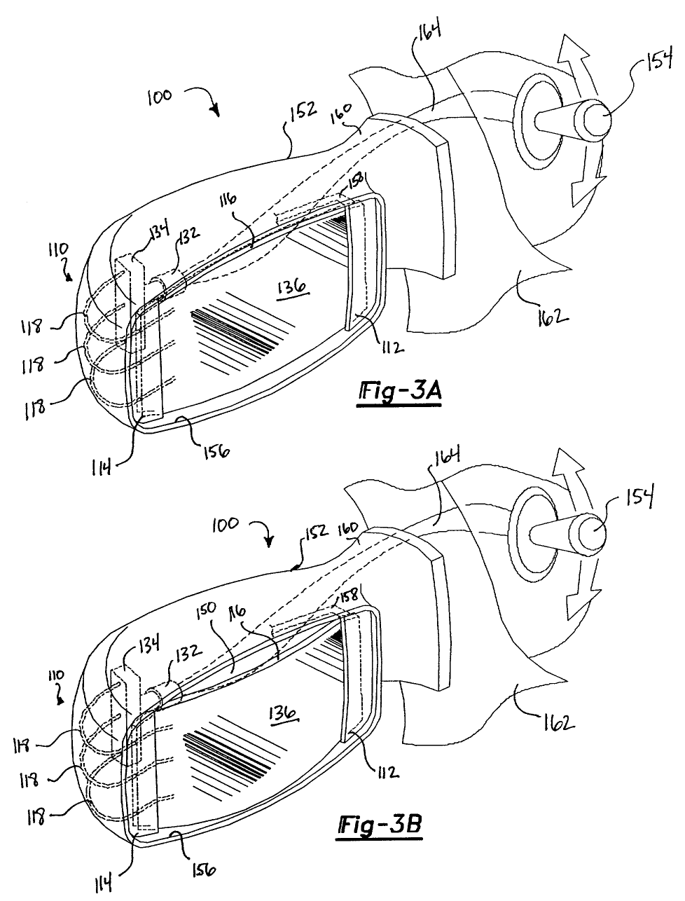

FIG. 3 illustrates a first preferred embodiment of a flexible mirror assembly 100 in accordance with the present invention. Like reference numbers in FIG. 3 refer to similar features and/or components illustrated in FIGS. 1 and 2. In FIG. 3, panel A illustrates a mirror assembly 100 in a non-activated, or non-deformed, configuration, while panel B illustrates a mirror assembly 100 in an activated configuration.

As shown in the figure, the mirror assembly 100 includes a mold line structure unit 110 with a flexible mirror surface 136 disposed within a recess 150 defined by a housing 152. Preferably, the assembly 100 also includes a controller 154 operably connected to the actuator 132 of the unit 110. In this embodiment, the actuator 132 interacts with a second end of the flexible rod 118 to induce deformation of the rods 118, flexible panel 116, and attached flexible mirror surface 136. Preferably, the actuator 132 includes an arm 134 and is attached to a second end of the rod 118 such that movement of the arm 134 pushes or pulls the second end of the rod 118 and, consequently, moves the second end with respect to the passageway 124, thereby inducing deformation of the rod 118, flexible panel 116, and flexible mirror surface 136.

A housing 152 preferably defines a recess 150 of suitable size for receiving the mold line structure unit 110 that includes the flexible mirror surface 136. As shown in FIG. 3, the recess 150 has an opening 156 that provides access to the recess 150. The opening 156 is preferably of suitable size for receiving the base member 112, the guide member 114, the flexible rod 118, the flexible panel 116, and the mirror surface 136 of the mold line structure unit 110. As illustrated in the figure, the flexible rod 118 is preferably configured such that the second end of the rod 118 is disposed behind the flexible panel 116. In this configuration, the actuator 132 is disposed behind the flexible panel 116 and within the recess 150 of the housing 152. This provides a compact arrangement for the flexible mirror assembly 100 of the present invention.

Alternatively, the flexible rod 118 can be arranged in a linear configuration or in any other suitable configuration, such as other curvilinear configurations.

As illustrated in FIG. 3, the mold line structure unit 110 is preferably positioned such that the flexible mirror surface 136 is substantially flush with the front of the housing member 152. To achieve this arrangement, the base 112 and guide members 114 are secured to the housing 152 in any suitable manner. For example, a mounting bracket 158 can be utilized to secure the base 112 and guide members 114 to the housing 152. Alternatively, any suitable securement means can be used, including fasteners and adhesives.

The housing member 152 can be formed from any suitable material, such as molded plastic. Preferably, as illustrated in FIG. 3, the housing 152 comprises a conventional side view mirror housing. In this embodiment, the housing 152 defines an attachment arm 160 that allows the entire assembly 100 to be secured to a surface. As such, the housing 152 is preferably secured to an exterior surface 162 of a motor vehicle (not illustrated). Alternatively, the housing 152 can comprise any structure suitable for enclosing the components of the assembly 100.

The controller 154 preferably comprises a manual control that allows an occupant of the vehicle to initiate and to control deformation of the flexible mirror surface 136. As such, the controller 154 is preferably disposed within the passenger compartment of the vehicle 164. Also, the controller 154 is operably connected to the actuator 132 of the mold line structure unit 110 of the assembly 100. The connector 164 between the controller 154 and actuator 132 is of a type appropriate for the type of actuator utilized in the mold line structure unit 110. Preferably, the connector 164 comprises a mechanical connection in which manipulation of the controller 154 results in movement of an element connected to the actuator 132, which initiates the actuator 132 to induce deformation of the flexible rod 118. Alternatively, the connector can comprise an electrical connection in which operation of the controller results in the transmission of an electrical signal to the actuator, thereby instructing the actuator to induce deformation of the flexible rod. Also alternatively, any suitable mechanical, electrical, or electromechanical connection can be used.

Various types of controls can be used for the controller 154. In this embodiment, a two position controller is preferred. For example, an on-off switch can be used. The on-off switch allows deformation to continue as long as the button is in the on position, and terminates deformation once the button is placed into the off position. Alternative types of controls include dials, toggle switches, and joystick type controllers.

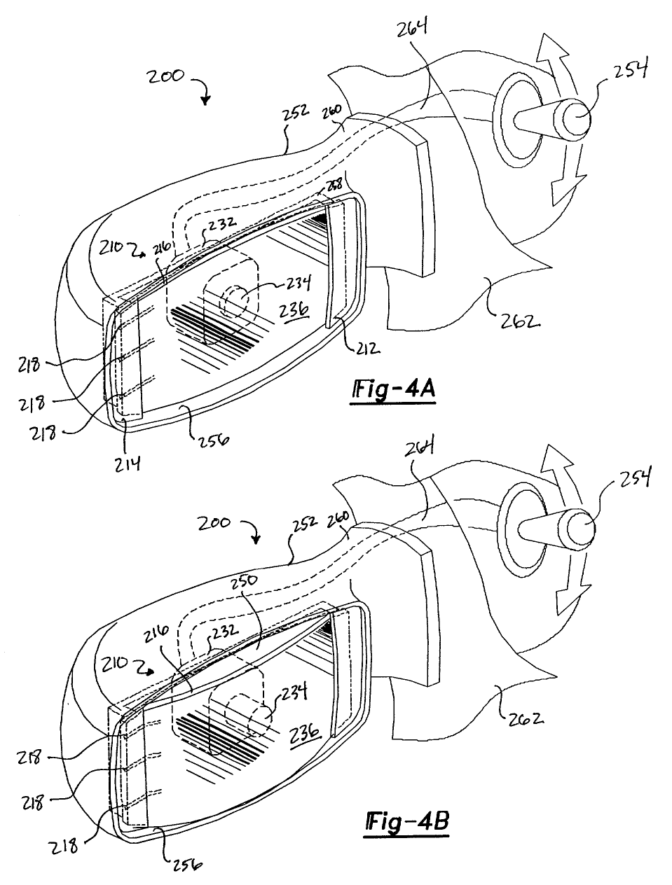

FIG. 4 illustrates a second preferred embodiment of the present invention. This embodiment is similar to the first preferred embodiment except as detailed below. Again, panel A illustrates a mirror assembly 200 in a non-activated, or non-deformed configuration, while panel B illustrates a mirror assembly 200 in an activated configuration. Like reference numbers in FIG. 4 refer to similar features and/or components of the first preferred embodiment.

In this embodiment, the flexible mirror assembly 200 includes an actuator 232 that is adapted to interact with the flexible rod 218 at a point between the base 212 and guide 214 members. As illustrated in FIG. 4, an arm 234 of the actuator 232 is directed at the rod 218 at a point between the base 212 and guide 214 members. The arm 234 can be attached to the rod 218 or flexible panel 216, or a clearance can exist between the arm 234 and these elements. If attached, the arm 234 is preferably adapted to push and pull the rod 218 and/or flexible panel 216, thereby inducing deformation of the flexible mirror surface 236. If a clearance exists between the arm 234 and these elements, the actuator 232 preferably induces deformation of the flexible mirror surface 236 by extending the arm 234 to a point at which it encounters the flexible panel 216 and subsequently pushing on the flexible panel 216. Preferably, this arrangement does not allow the actuator 232 to induce deformation by pulling on the rod 218 or the flexible panel 216.

As illustrated in FIG. 4, a second end of the rod 218 in this embodiment is preferably not attached to the actuator 232. As such, the rod 218 can be eliminated from the assembly 200 if the flexible panel 216 is sufficient to support the flexible mirror surface 216 and allow the desired flexibility.

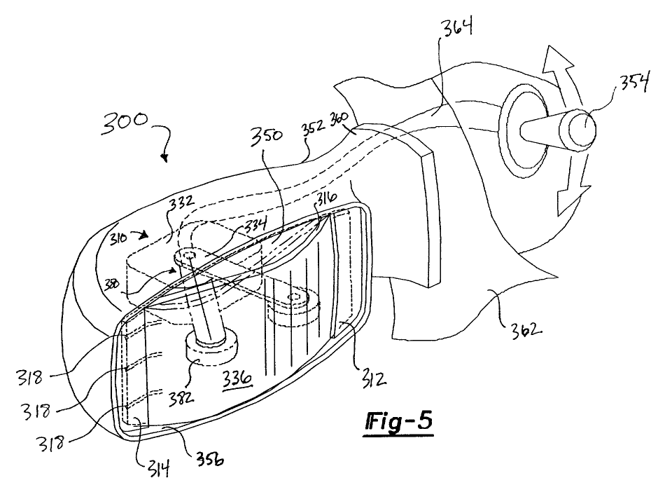

FIG. 5 illustrates a third preferred embodiment of the present invention. This embodiment is similar to the second preferred embodiment except as detailed below and like reference numbers in FIG. 5 refer to similar features and/or components of the second preferred embodiment.

In this embodiment, the flexible mirror assembly 300 includes an actuator 332 that includes a roller assembly 380 adapted to interact with the rod 318 and/or flexible panel 316 to induce deformation of the flexible mirror surface 336. The roller assembly 380 preferably comprises an arm 334 of the actuator 332 and a roller 382 operably connected to the arm 334. The roller 382 is able to rotate along a surface of the rod 318 and/or flexible panel 316 in response to movement of the arm 334. As illustrated in FIG. 5, the roller 382 is preferably positioned to interact with the surface of the rod 318 and/or flexible panel 316 that faces the inside of the recess 350 of the housing 352. Also preferable, the roller assembly 380 is oriented such that the roller 382 can move along a length of the flexible panel 316 between the base 312 and guide 314 members.

The roller assembly 380 allows for an incremental change in the curvature of the flexible mirror surface 336 by moving the roller 382 along the length of the rod 318 and/or flexible panel 316.

In this embodiment, the controller 354 preferably comprises a joystick type controller that is movable between three positions. A first position activates the actuator 332 such that the roller 382 moves along the rod 318 and/or flexible panel 316 toward the base member 312. The second position preferably activates the actuator 332 such that the roller 382 moves along the rod 318 and/or flexible panel 316 toward the guide member 314, i.e., a direction opposite the direction associated with the first position. A neutral position results in no movement of the roller 382.

In any of the embodiments of the present invention, the rods and/or panel can be adapted to provide heating and/or cooling to the flexible mirror surface. By changing the temperature of the rods and/or panel, the adjacent flexible mirror surface is heated or cooled by heat transfer from these elements. For example, the rods can be made of a resistive material that warms when an electrical current from an attached electrical circuit is passed through the rod. Alternatively, any suitable method or apparatus for heating or cooling the rods and/or panel can be used. Also alternatively, the mirror surface can be heated or cooled directly.

The foregoing disclosure is the best mode devised by the inventors for practicing the invention. It is apparent, however, that several variations in accordance with the present invention may be conceivable to one of ordinary skill in the relevant art. Inasmuch as the foregoing disclosure is intended to enable such person to practice the instant invention, it should not be construed to be limited thereby, but should be construed to include such aforementioned variations. As such, the present invention should be limited only by the spirit and scope of the following claims.

We claim:

1. A flexible mirror comprising:
a base member;
a guide member having first and second opposing faces and defining a passageway extending between the first and second opposing faces;
at least one flexible rod having first and second ends, the first end being fixedly attached to the base member and the second end being disposed in the passageway and being capable of slideable movement within the passageway;
a flexible panel disposed around the rod and between the base and guide members;
a mirror surface disposed on the flexible panel; and
an actuator adapted to induce deformation of the rod;
wherein deformation of the rod causes the flexible panel and mirror surface to deform, thereby altering an angle at which the mirror surface reflects light.

2. A flexible mirror in accordance with claim 1, wherein the mirror surface comprises a reflective layer formed of a metallic film.

3. A flexible mirror in accordance with claim 1, wherein the actuator comprises a mechanical actuator attached to the second end of the rod and adapted to selectively push or pull the second end of the rod with respect to the passageway in order to induce deformation of the rod.

4. A flexible mirror in accordance with claim 1, wherein the actuator is adapted to push the flexible panel at a point between the first and second ends.

5. A flexible mirror in accordance with claim 4, wherein the actuator includes a roller assembly having a support arm and a roller wherein the roller rotates about a portion of the support arm and rolls along a length of the flexible panel.

6. A flexible mirror in accordance with claim 1, further comprising a housing member defining a recess and an opening wherein the base and guide members are secured to the housing member such that the mirror surface is positioned within the opening in a matter that allows the mirror surface to reflect light directed at the mirror surface from outside the housing member.

7. A flexible mirror in accordance with claim 6, wherein the actuator is disposed within the recess of the housing member.

8. A flexible mirror in accordance with claim 1, further comprising an electrical circuit connected to the rod, wherein the rod comprises a resistive material adapted to warm the flexible panel and mirror surface when the electrical circuit causes an electrical current to flow across the rod.

9. A mirror assembly for use in a vehicle having an exterior surface and an interior passenger compartment, the assembly comprising:
a housing member defining a recess and an opening;
a base member secured to the housing member;
a guide member secured to the housing member, the guide member having first and second opposing faces and defining a passageway extending between the first and second opposing faces;
at least one flexible rod having first and second ends, the first end being fixedly attached to the base member and the second end being disposed in the passageway and being capable of slideable movement within the passageway;
a flexible panel disposed around the rod and between the base and guide members;
a flexible mirror surface disposed on the flexible panel and positioned within the opening in a manner that allows the mirror surface to reflect light directed at the mirror surface from outside the housing member; and
an actuator adapted to induce deformation of the rod;
wherein deformation of the rod causes the flexible panel and mirror surface to deform, thereby altering an angle at which the mirror surface reflects light.

10. A mirror assembly in accordance with claim 9, further comprising a controller operably connected to the actuator and adapted to engage the actuator to induce deformation of the rod.

11. A mirror assembly in accordance with claim 10, wherein the housing member is secured to said exterior surface and the controller is positioned within said interior passenger compartment.

12. A mirror assembly in accordance with claim 9, wherein the actuator comprises a mechanical actuator attached to the second end of the rod and adapted to selectively push or pull the second end of the rod with respect to the passageway in order to induce deformation of the rod.

13. A mirror assembly in accordance with claim 9, wherein the actuator is adapted to push the flexible panel at a point between the first and second ends.

14. A mirror assembly in accordance with claim 13, wherein the actuator includes a roller assembly having a support arm and a roller, wherein the roller rotates about a portion of the support arm and rolls along a length of the flexible panel.

15. A mirror assembly in accordance with claim 14, further comprising a controller operably connected to the actuator and adapted to engage the actuator to induce the roller to roll along the flexible panel.

16. A mirror assembly in accordance with claim 15, wherein the controller comprises a joystick controller.

17. A mirror assembly for use in a vehicle having an exterior surface and an interior passenger compartment the assembly comprising:
a housing member defining a recess and an opening;
a base member secured to the housing member;
a guide member secured to the housing member, the guide member having first and second opposing faces and defining a passageway extending between the first and second opposing faces;
at least one flexible rod having first and second ends, the first being fixedly attached to the base member and the second end being disposed in the passageway and being capable of slideable movement within the passageway;
a flexible panel disposed around the rod and between the base and guide members,
a flexible mirror surface disposed on the flexible panel and positioned within the opening in a manner that allows the mirror surface to reflect light directed at the mirror surface from outside the housing member;
means for inducing deformation of the rod;
wherein deformation of the rod causes the flexible panel and mirror surface to deform, thereby altering an angle at which the mirror surface reflects light.

18. A mirror assembly in accordance with claim 17, further comprising means for controlling the means for inducing deformation of the rod.

19. A mirror assembly in accordance with claim 18, wherein the housing member is secured to said exterior surface and the means for controlling the means for inducing deformation are positioned within said interior passenger compartment.

20. A mirror assembly in accordance with claim 19, further comprising means for heating the mirror surface.
